(19) United States
(12) Patent Application Publication
(10) Pub. No.: US 2018/0205998 A1
(43) Pub. Date: Jul. 19, 2018

(54) ELECTRONIC APPARATUS AND METHOD FOR BROADCASTING SCHEDULE THEREOF

(71) Applicant: Samsung Electronics Co., Ltd., Suwon-si (KR)

(72) Inventor: Hyun-chul CHO, Seoul (KR)

(73) Assignee: Samsung Electronics Co., Ltd., Suwon-si (KR)

(21) Appl. No.: 15/718,808

(22) Filed: Sep. 28, 2017

(30) Foreign Application Priority Data
Jan. 17, 2017 (KR) 10-2017-0008192

(51) Int. Cl. H04N 21/472; H04N 21/458; H04N 21/431; H04N 21/433

(52) U.S. Cl. CPC H04N 21/47202; H04N 21/433; H04N 21/4312; H04N 21/458

(57) ABSTRACT

An electronic apparatus is provided that includes: a communicator performing communication with a server; and a processor providing a user interface that receives information on a previous broadcasting program broadcast before a broadcasting program and a subsequent broadcasting program broadcast after the broadcasting program on a channel on which the broadcasting program is broadcast from the server and indicates a broadcasting schedule for at least one for the previous broadcasting program, the broadcasting program, and the subsequent broadcasting program based on the information on the received broadcasting program.

### CROSS-REFERENCE TO RELATED APPLICATIONS

This application claims priority from Korean Patent Application No. 10-2017-0008192, filed on Jan. 17, 2017 in the Korean Intellectual Property Office the disclosure of which is incorporated herein by reference in its entirety.

### BACKGROUND

### Field

Apparatuses and methods consistent with the present disclosure relate to an electronic apparatus and a method for providing a broadcasting schedule thereof, and more particularly, to an electronic apparatus capable of providing a broadcasting schedule and a method for providing a broadcasting schedule thereof.

### Description of the Related Art

In recent years, a user has been able to watch not only a broadcasting program currently being broadcast but also a broadcasting program that was previously broadcast through video on demand (VOD).

However, in order for a user to watch a broadcasting program through the VOD service, the user needs to search for the broadcasting programs that he/she wishes to watch. For this purpose, a user needs to accurately know program information such as a name and a genre of a broadcasting program.

In addition, for example, if a user wishes to watch a broadcasting program, which was broadcast in the current time zone a few days ago, through the VOD, he/she needs to perform a complicated process of first checking what broadcasting program was broadcast in the current time zone a few days ago and then searching the broadcasting program separately, which makes the user uncomfortable.

### SUMMARY

Exemplary embodiments of the disclosure overcome the above disadvantages and other disadvantages not described above. Also, the embodiments are not required to overcome the disadvantages described above, and an exemplary embodiment may not overcome any of the problems described above.

The present disclosure provides an electronic apparatus capable of providing a broadcasting schedule for a broadcasting program, which is broadcast before and/or after a broadcasting program that a user is currently watching through various sources and a method for providing a broadcasting schedule thereof.

According to an aspect of the present disclosure, an electronic apparatus includes: a communicator performing communication with a server; and a processor providing a user interface that receives information on a previous broadcasting program broadcast before a broadcasting program and a subsequent broadcasting program broadcast after the broadcasting program on a channel on which the broadcasting program is broadcast from the server and indicates a broadcasting schedule for at least one for the previous broadcasting program, the broadcasting program, and the subsequent broadcasting program based on the information on the received broadcasting program.

The processor may receive the broadcasting program from the server in which a plurality of broadcasting programs are stored.

The processor may provide the user interface in a progress bar type in which the previous broadcasting program, the broadcasting program, and the subsequent broadcasting program are divided in broadcasting program units and arranged in order of broadcasting time.

The information on the broadcasting program may include names and broadcasting time of the previous broadcasting program, the broadcasting program, and the subsequent broadcasting program.

The server may store information on the broadcasting programs broadcast before and after the broadcasting program, on each broadcasting program basis.

If or when information on a first previous broadcasting program broadcast before the broadcasting program is received, the processor may request information on a broadcasting program broadcast before the first previous broadcasting program to the server based on the information on the first previous broadcasting program and receive information on a second previous broadcasting program broadcast before the first previous broadcasting program from the server.

If or when information on a first subsequent broadcasting program broadcast after the broadcasting program is received, the processor may request information on a broadcasting program broadcast after the first subsequent broadcasting program to the server based on the information on the first subsequent broadcasting program and receive a second subsequent broadcasting program broadcast after the first subsequent broadcasting program from the server.

If or when the broadcasting program is selected on the user interface, the processor may receive the selected broadcasting program from the server.

According to another aspect of the present disclosure, a method for providing a broadcasting schedule of an electronic apparatus includes: receiving information on a previous broadcasting program broadcast before the broadcasting program and information on a subsequent broadcasting program broadcast after the broadcasting program on a channel on which the broadcasting program is broadcast from a server; and providing a user interface indicating a broadcasting schedule for at least one of the previous broadcasting program, the broadcasting program, and the subsequent broadcasting program based on the information on the received broadcasting program.

The method may further include: receiving the broadcasting program from the server storing a plurality of broadcasting programs.

In the displaying, a user interface in a progress bar type in which the previous broadcasting program, the broadcasting program, and the subsequent broadcasting program are divided in broadcasting program units and arranged in order of broadcasting time may be provided.

The information on the broadcasting program may include names and broadcasting time of the previous broadcasting program, the broadcasting program, and the subsequent broadcasting program.

The server may store information on broadcasting programs broadcast before and after the broadcasting program, on each broadcasting program basis.

The method may further include: requesting information on a broadcasting program broadcast before a first previous broadcasting program to the server based on the first previous broadcasting program and receiving information on a second previous broadcasting program broadcast before the first previous broadcasting program from the server, if or when the information on the first previous broadcasting program broadcast before the broadcasting program is received.

The method may further include: requesting information on a broadcasting program broadcast after a first subsequent broadcasting program to the server based on the information on the first subsequent broadcasting program and receiving information on a second subsequent broadcasting program broadcast after the first subsequent broadcasting program from the server, if or when the information on the first subsequent broadcasting program broadcast after the broadcasting program is received.

The method may further include: receiving a selected broadcasting program from the server if or when the broadcasting program is selected on the user interface.

According to various exemplary embodiments of the present disclosure as described above, the user can acquire the information on the broadcasting program broadcast before and/or after the broadcasting program that he/she is currently watching and watch the corresponding broadcasting program by interworking with the VOD service, thereby improving the user convenience.

### BRIEF DESCRIPTION OF THE DRAWING FIGURES

The above and/or other aspects will be more apparent by describing certain exemplary embodiments with reference to the accompanying drawings, in which:

FIG. 1 is a block diagram for describing a configuration of a server according to an exemplary embodiment of the present disclosure;

FIG. 2 is a block diagram for describing a configuration of a electronic apparatus according to an exemplary embodiment of the present disclosure;

FIGS. 3 to 9 are diagrams for describing a method for providing a user interface according to various exemplary embodiments of the present disclosure;

FIG. 10 is a block diagram for describing a detailed configuration of the electronic apparatus according to the exemplary embodiment of the present disclosure; and

FIG. 11 is a flow chart for describing a method for providing a broadcasting schedule of an electronic apparatus according to an exemplary embodiment of the present disclosure.

### DETAILED DESCRIPTION OF THE EXEMPLARY EMBODIMENTS

Prior to describing in detail the present disclosure, a description method of the present specification and drawings will be described.

Further, the terminologies used in the present disclosure are selected as general terminologies currently widely used in consideration of the configuration and functions of the present disclosure, but may be different depending on intention of those skilled in the art, a precedent, appearance of new technologies, and the like. Further, in specific cases, terms arbitrarily selected by an applicant are present. In this case, the detailed meaning of the terms will be described in the description of the present disclosure. Therefore, terms used in the present disclosure are defined based on a meaning of the terms and contents described in the present disclosure, not simply based on names of the terms.

In the present specification, unless explicitly described to the contrary, “comprising” any components will be understood to imply the inclusion of other components rather than the exclusion of any other elements. Terms “components”, “unit”, “module”, or the like described in the specification mean a unit for processing at least one function or operation and may be implemented by hardware or software or a combination of hardware and software.

Hereinafter, exemplary embodiments of the present disclosure will be described in detail with reference to the accompanying drawings so that those skilled in the art may easily practice the present disclosure. However, the present disclosure may be modified in various different ways and is not limited to exemplary embodiments provided in the present description. In the accompanying drawings, portions unrelated to the description will be omitted in order to obviously describe the present disclosure, and similar reference numerals will be used to describe similar portions throughout the present specification.

Hereinafter, exemplary embodiments of the present disclosure will be described in more detail with reference to the accompanying drawings.

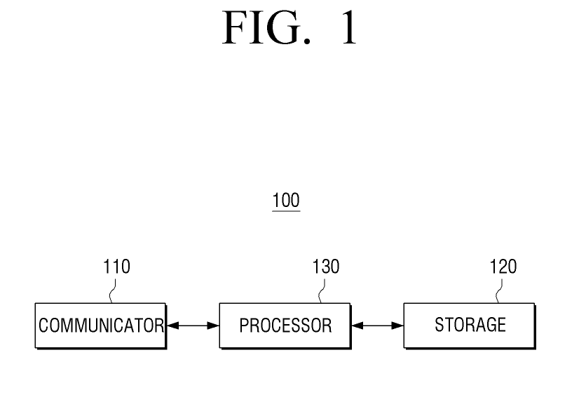

FIG. 1 is a block diagram for describing a configuration of a server according to an exemplary embodiment of the present disclosure.

Referring to FIG. 1, a server 100 includes a communicator 110, a storage 120, and a processor 130.

In this case, the server 100 may be implemented as a server for providing a VOD service.

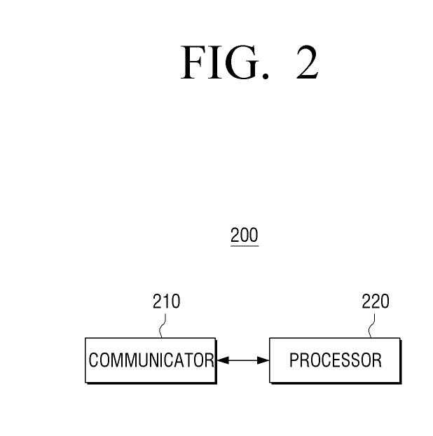

The communicator 110 performs communication with an electronic apparatus 200 (FIG. 2). In this case, the communicator 110 may be connected to a network (not illustrated) through various types of communication methods and may perform the communication with the electronic apparatus 200 through the network (not illustrated). To this end, the communicator 110 may include a communication module for performing wired Ethernet, wireless LAN communication, and the like.

The storage 120 stores a broadcasting program. That is, the storage 120 may store video data and audio data for a plurality of broadcasting programs.

In addition, the storage 120 stores information on broadcasting programs, on each broadcasting program basis.

Specifically, the storage 120 may store information on names, broadcasting time, or the like of each broadcasting program and information on names, broadcasting time, or the like of previous and subsequent broadcasting programs, on each broadcasting program basis.

Here, the previous broadcasting program means a broadcasting program broadcast immediately before a broadcasting program on a channel on which the broadcasting program is broadcast, and the subsequent broadcasting program means a broadcasting program broadcast immediately after the broadcasting program on the channel on which the broadcasting program is broadcast.

For example, broadcasting stations, broadcasters, or the like may provide broadcasting programs, such as a ground wave, through a broadcasting channel allocated to a broadcasting frequency, and a user may watch broadcasting programs provided by the broadcasting stations or broadcasters in real time (i.e., live).

In this case, the storage 120 may store information on a previous broadcasting program and a subsequent broadcasting program of the broadcasting program provided through the broadcasting channel.

For example, the case where broadcasting program A is broadcast on CH 22 from 20:00 to 22:00 on Sunday, broadcasting program B is broadcast on the CH 22 from 19:00 to 20:00 on Sunday before the broadcasting program A is broadcast, and broadcasting program C is broadcast on the CH 22 from 22:00 to 23:30 on Sunday after the broadcasting program A is broadcast is assumed.

In this case, in connection with the broadcasting program A, the storage 120 stores information on a name, a broadcasting time, or the like of the broadcasting program A, information on a name, a broadcasting time, or the like of the broadcasting program B which is the previous broadcasting program, and information on a name, a broadcasting time, or the like of the broadcasting program C which is the subsequent broadcasting program.

Meanwhile, the example described above assumes the case where the broadcasting program B is broadcast on the CH 22 from 19:00 to 20:00 on Sunday, and broadcasting program D is broadcast on the CH 22 from 18:00 to 19:00 on Sunday before broadcasting program B is broadcast.

In this case, in connection with the broadcasting program B, the storage 120 stores information on a name, a broadcasting time, or the like of the broadcasting program B, information on a name, a broadcasting time, or the like of the broadcasting program D which is the previous broadcasting program, and information on a name, a broadcasting time, or the like of the broadcasting program A which is the subsequent broadcasting program.

Further, the example described above assumes the case where the broadcasting program C is broadcast on the CH 22 from 22:00 to 23:30 on Sunday and the broadcasting program E is broadcast on the CH 22 from 23:30 to 24:00 on Sunday before the broadcasting program C is broadcast.

In this case, in connection with the broadcasting program C, the storage 120 stores the information on the name, the broadcasting time, or the like of the broadcasting program C, the information on the name, the broadcasting time, or the like of the broadcasting program A which is the previous broadcasting program, and information on a name, a broadcasting time, or the like of a broadcasting program E which is the subsequent broadcasting program.

The processor 130 controls a general operation of the server 100. For example, the processor 130 may drive an operating system or application programs to control hardware or software components connected to the processor 130 and may perform various data processing and operations. In addition, the processor 130 may load commands or data received from at least one of other components into a volatile memory and process the commands, and store various data in a non-volatile memory.

For this purpose, the processor 130 may be implemented by a dedicated processor (e.g., embedded processor) for performing the corresponding operations or a generic-purpose processor (e.g., CPU or application processor) that may perform the corresponding operations by executing one or more software program stored in a memory device.

Meanwhile, the processor 130 may transmit the broadcasting program to the electronic apparatus 200 through the communicator 110. That is, the processor 130 may transmit video data and audio data for a broadcasting program to the electronic apparatus 200.

Further, the processor 130 may transmit the information on the broadcasting program to the electronic apparatus 200 through the communicator 110.

First of all, the processor 130 may transmit the information on the name, the broadcasting time, or the like of the broadcasting program to the electronic apparatus 200.

Further, the processor 130 may transmit the information on the names, the broadcasting time, or the like of the previous and subsequent broadcasting programs of the broadcasting program to the electronic apparatus 200.

Specifically, if the information on the name, the broadcasting time, or the like of the broadcasting program is received from the electronic apparatus 200, the processor 130 may determine the broadcasting program matching the corresponding information and transmit the information on the names, the broadcasting time, or the like of the previous and subsequent broadcasting programs of the determined broadcasting program to the electronic apparatus 200.

For example, in connection with the broadcasting program A broadcast on CH 22 from 20:00 to 22:00 on Sunday, the case where the storage 120 stores the information on the name and the broadcasting time of the broadcasting program A, and the information on the names, the broadcasting time, or the like of the broadcasting programs B and C which are the previous and subsequent broadcasting programs of the broadcasting program A is assumed.

In this case, if receiving the information on the name, the broadcasting time, or the like of the program A from the electronic apparatus 200, the processor 130 may determine the broadcasting program matching the received name, broadcasting time, or the like as the broadcasting program A and transmit the information on the names, the broadcasting time, or the like of the broadcasting programs B and C which are the previous and subsequent broadcasting programs of the broadcasting program A to the electronic apparatus 200.

FIG. 2 is a block diagram for describing a configuration of the electronic apparatus according to the exemplary embodiment of the present disclosure.

Referring to FIG. 2, the electronic apparatus 200 may include a communicator 210 and a processor 220.

In this case, the electronic apparatus 200 may be implemented as TV. However, this is merely an example, and the electronic apparatus 200 may be implemented as various types of devices such as a smart phone, a tablet, a wearable device, and a set-top box.

The communicator 210 performs communication with the server. In this case, the communicator 210 may be connected to a network (not illustrated) through various types of communication methods and may perform the communication with the server 100 through the network (not illustrated). To this end, the communicator 210 may include a communication module for performing the wired Ethernet, the wireless LAN communication, and the like.

The processor 220 controls a general operation of the electronic apparatus 200. For example, the processor 220 may drive an operating system or application programs to control hardware or software components connected to the processor 220 and may perform various data processing and operations. In addition, the processor 220 may load commands or data received from at least one of other components into a volatile memory and process the commands, and store various data in a non-volatile memory.

For this purpose, the processor 220 may be implemented by a dedicated processor (e.g., embedded processor) for performing the corresponding operations or a generic-purpose processor (e.g., CPU or application processor) that may perform the corresponding operations by executing one or more software program stored in a memory device.

First of all, the processor 220 may output a broadcasting program.

For example, the processor 220 may display video data for a broadcasting program on a display (not illustrated) provided in the electronic apparatus 200 and output audio data for the broadcasting program to a speaker (not illustrated) provided in the electronic apparatus 200.

In this case, however, if the electronic apparatus 200 includes only the display (not illustrated) without the speaker (not illustrated), the processor 220 displays the video data for the broadcasting program on the display (not illustrated), and if the electronic apparatus 200 includes only the speaker (not illustrated) without the display (not illustrated), the processor 220 may output the audio data for the broadcasting program to the electronic apparatus 200 through the speaker (not illustrated).

Further, the processor 220 may transmit the video data and the audio data for the broadcasting program to an external device (not illustrated) that is connected to the electronic apparatus 200. In this case, the external device (not illustrated) may output the video data and the audio data received from the electronic apparatus 200 through the display (not illustrated) and the speaker (not illustrated) of the external device. In this case, the broadcasting program may be provided in various ways. For example, the electronic apparatus 200 may receive broadcasting programs that broadcasting stations, broadcasters, or the like provide through a broadcasting channel and output the broadcasting programs in real time. In addition, the electronic apparatus 200 may receive the broadcasting program from the server 100 (e.g., FIG. 1) that provides a VOD service and output the received broadcasting program. In addition, the electronic apparatus 200 may use a personal video recorder (PVR) function to store a broadcasting program in a storage medium provided in the electronic apparatus 200 or an external storage medium connected to the electronic apparatus 200 and output the stored broadcasting program.

Meanwhile, if the broadcasting program is provided from the server 100, the processor 220 may receive the broadcasting program from the server 100 that stores a plurality of broadcasting programs. First of all, the processor 220 may output a broadcasting program.

To this end, the processor 220 may request the server 100 to transmit the broadcasting program through the communicator 210.

For example, the processor 220 may transmit a keyword input from a user to the server 100, receive the broadcasting program searched by the keyword from the server 100 through the communicator 210, and output the received broadcasting program. As another example, the processor 220 may receive a broadcasting program, which is searched by a search menu provided from the server 100, from the server 100 through the communicator 100 and output the received broadcasting program.

Meanwhile, the processor 220 may control the communicator 210 to receive the information on the previous broadcasting program broadcast before the broadcasting program and the subsequent broadcasting program broadcast after the broadcasting program from the server 100 on the channel on which the broadcasting program is broadcast.

To this end, if a user command is input, the processor 220 may request the server 100 to transmit the information on the previous and subsequent broadcasting programs of the broadcasting program that is currently being output.

For example, the processor 220 may request the server 100 to transmit the information on the previous and subsequent broadcasting programs of the broadcasting program that is currently being output, if the user command is input in the state in which the broadcasting program is output through at least one of the display (not illustrated) and the speaker (not illustrated) provided in the electronic apparatus 200.

As another example, if a user command is input in the state where the broadcasting program is transmitted to the external device, the processor 220 may request the server 100 to transmit the information on the previous and subsequent broadcasting programs of the broadcasting program that is currently being output.

Here, the user command may be a search command for the previous and subsequent broadcasting programs, which may be input through a keypad provided in the electronic apparatus 200 or through a remote control for controlling the electronic apparatus 200.

For example, a user may press a key (for example, a fast forward (FF) key and a rewind (REW) key) prepared for changing a playback point of the broadcasting program in the VOD service or the PVR service for a preset time or by a preset frequency to input commands for searching for the previous and subsequent broadcasting programs. However, this is merely an example, and the user command may be input in various ways.

Meanwhile, if the user command is input, the processor 220 may transmit the information on the broadcasting program that is currently being output to the server 100 through the communicator 210.

In this case, the information on the broadcasting program may include the name, the broadcasting time, or the like of the broadcasting program.

At this point, the processor 220 can acquire the information on the broadcasting program in various ways.

For example, if the broadcasting program that is currently being output is a broadcasting program provided in real time via a broadcasting channel, the information on the broadcasting program may be provided to the electronic apparatus 200 through the broadcasting channel. In addition, when if the broadcasting program is provided through the VOD service, the information on the broadcasting program may be provided from the server 100 to the electronic apparatus 200. In addition, in the case of the PVR service, the information on the broadcasting program may be stored in the storage medium along with the broadcasting program, and the electronic apparatus 200 may acquire the information on the broadcasting program from the storage medium

In this case, if the information on the broadcasting program is received from the electronic apparatus 200, the server 100 may determine the broadcasting program matching the information on the corresponding broadcasting program and transmit the information on the broadcasting programs broadcast before and after the determined broadcasting program to the electronic apparatus 200.

Accordingly, the processor 220 may receive the information on the previous and subsequent broadcasting programs of the broadcasting program that is currently being output through the communicator 210.

Meanwhile, the processor 220 may acquire the information on the previous broadcasting program broadcast before the corresponding broadcasting program from the server, based on the information on the previous broadcasting program.

Specifically, if information on a first previous broadcasting program broadcast before the broadcasting program is received, the processor 220 may request to the server 100 the information on the broadcasting program broadcast before the first previous broadcasting program based on the first previous broadcasting program and acquire information on a second previous broadcasting program broadcast before the first previous broadcasting program from the server 100.

That is, the processor 220 may transmit the information on the previous broadcasting program to the server 100 through the communicator 210. In this case, the information on the previous broadcasting program may include the name, the broadcasting time, or the like of the broadcasting program broadcast before the broadcasting program that is currently being output.

At this point, if the information on the previous broadcasting program is received from the electronic apparatus 200, the server 100 may determine the broadcasting program matching the information on the corresponding broadcasting program and transmit the information on the broadcasting programs broadcast before and after the determined broadcasting program to the electronic apparatus 200.

Accordingly, the processor 220 may receive the information on the broadcasting information broadcast before the previous broadcasting program of the broadcasting program that is currently being output through the communicator 210.

Further, the processor 220 may acquire the information on the subsequent broadcasting program broadcast after the corresponding broadcasting program from the server 100, based on the information on the subsequent broadcasting program.

Specifically, if information on a first subsequent broadcasting program broadcast after the broadcasting program is received, the processor 220 may request to the server 100 the information on the broadcasting program broadcast after the first subsequent broadcasting program based on the first subsequent broadcasting program and acquire information on a second subsequent broadcasting program broadcast after the first subsequent broadcasting program from the server 100.

That is, the processor 220 may transmit the information on the subsequent broadcasting program to the server 100 through the communicator 210. In this case, the information on the subsequent broadcasting program may include the name, the broadcasting time, or the like of the broadcasting program broadcast after the broadcasting program that is currently being output.

At this point, if the information on the subsequent broadcasting program is received from the electronic apparatus 200, the server 100 may determine the broadcasting program matching the information on the corresponding broadcasting program and transmit the information on the broadcasting programs broadcast before and after the determined broadcasting program to the electronic apparatus 200.

Accordingly, the processor 220 may receive the information on the broadcasting information broadcast after the subsequent broadcasting program of the broadcasting program that is currently being output through the communicator 210.

In this way, the processor 220 may acquire the information on the broadcasting program sequentially broadcast before the broadcasting program that is currently being output and the information on the broadcasting program sequentially broadcast after the broadcasting program that is currently being output.

Meanwhile, the processor 220 provides a user interface indicating a broadcasting schedule for at least one of the previous broadcasting program, the broadcasting program, and the subsequent broadcasting program based on the information on the previous broadcasting program, the broadcasting program, and the subsequent broadcasting program.

For example, the processor 220 may display a user interface indicating a broadcasting schedule on a display (not illustrated) provided in the electronic apparatus 200.

As another example, the processor 220 may transmit graphic data for the user interface indicating the broadcasting schedule to an external device (not illustrated). In this case, the external device (not illustrated) may display the user interface using the received graphic data.

Meanwhile, the processor 220 may provide a user interface in a progress bar type in which the previous broadcasting program, the broadcasting program, and the subsequent broadcasting program are divided in a broadcasting program unit and arranged in order of broadcasting time.

Further, if the broadcasting program is selected on the user interface, the processor 220 may receive the broadcasting program selected from the server 100.

Specifically, the processor 220 may request the server 100 to transmit the selected broadcasting program through the communicator 210 according to a user command on the user interface and receive the corresponding broadcasting program from the server 100. Further, the processor 220 may output the broadcast program received from the server 100 through at least one of the display (not illustrated) and the speaker (not illustrated) provided in the electronic apparatus 200. In addition, the processor 220 may transmit the broadcasting program received from the server 100 to the external device.

Further, if the broadcasting program is selected on the user interface, the processor 220 may provide a graphical user interface (GUI) for inquiring whether or not to purchase the corresponding broadcasting program.

For example, the processor 220 may display the GUI for inquiring whether or not to purchase a broadcasting program on the display (not illustrated) provided in the electronic apparatus 200. Further, the processor 220 may transmit the graphic data on the GUI for inquiring whether or not to purchase the broadcasting program to the external device (not illustrated). At this point, the external device (not illustrated) can display the GUI for inquiring whether or not to purchase a broadcasting program through the graphic data.

Further, the processor 220 may receive a broadcasting program selected from the server 100 if a user command for purchase is input through the GUI.

Meanwhile, the progress bar generally has a bar shape of the entire broadcasting time length of the broadcasting program and indicates a current playback point by a method of displaying a current playback point while moving the current playback point on a bar. At this point, since the VOD service or the PVR service provides a stored broadcasting program rather than providing a broadcasting program live, it may control a broadcasting program, which is currently being played, until a playback point of the broadcast program by using the progress bar. For example, a user may move the GUI in the progress bar and receive a broadcasting program from his/her desired playback point.

In the present disclosure, schedule information for a broadcasting program may be provided using the progress bar that performs the function, which will be described in more detail with reference to the accompanying drawings.

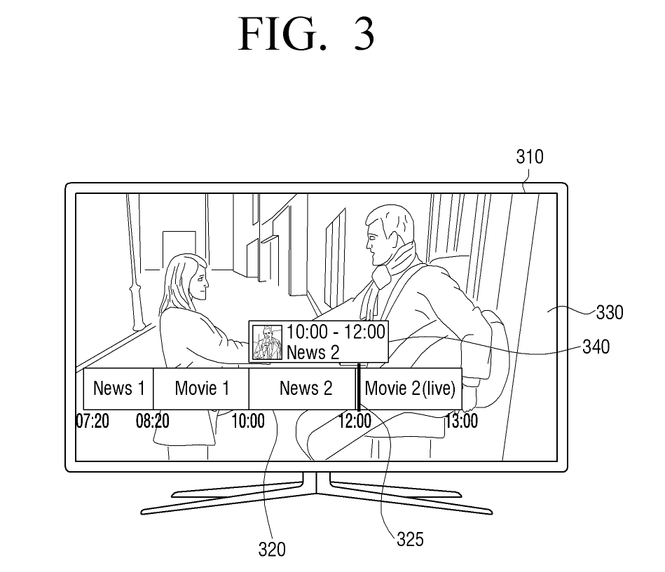

FIGS. 3 to 9 are diagrams for describing a method of providing a user interface according to various exemplary embodiments of the present disclosure.

Meanwhile, in FIGS. 3 to 9, it is assumed that the electronic apparatus 200 includes a display (not illustrated) for convenience of explanation.

First, FIG. 3 illustrates an example of the a user interface provided in a state in which the electronic apparatus 200 outputs a broadcasting program provided through a broadcasting channel in real time.

If a user command for searching for previous and subsequent broadcasting programs is input in a state in which a broadcasting program provided through a broadcasting channel is output in real time, the processor 220 may a user interface indicating schedule information to a display (not illustrated) based on information on the previous and subsequent broadcasting programs that are received from the server 100.

Here, the user command for searching for the previous and subsequent broadcasting programs may be a command for selecting a key (e.g., REW key or FF key) prepared for changing a playback point.

For example, as illustrated in FIG. 3, it is assumed that the electronic apparatus 200 receives and displays movie 2 330 broadcast on CH2 at 12:10 on Sunday from a broadcasting station, or the like. Here, news 1 was broadcast on CH 2 from 07:20 to 08:20 on Sunday, movie 1 was broadcast on CH 2 from 08:20 to 10:00 on Sunday, and news 2 was broadcast on CH 2 from 10:00 to 12:00 on Sunday.

In this case, the processor 220 may output a user interface 320 indicating a schedule for movie 2 and a broadcasting program broadcast on CH 2 before the movie 2 is broadcast to the display 310 based on the information on the broadcasting program received from the server 100, as illustrated in FIG. 3.

The user interface 320 is displayed in the progress bar type and may include a GUI in which broadcasting programs such as news 1, movie 1, news 2, and movie 2 are divided in program units. In this case, each GUI may display broadcasting time (07:20 to 08:20, 08:20 to 10:00, 10:00 to 12:00, 12:00 to 13:00) when the corresponding broadcasting program is broadcast.

Further, as illustrated in FIG. 3, the processor 220 may display an object 325 (e.g., bar-shaped GUI) for indicating a current playback point of the corresponding broadcasting program within the GUI for a broadcasting program which is currently being output.

In addition, if a cursor displayed on a screen moves to the user interface, the processor 220 may display information on a broadcasting program where the cursor is located on the user interface. For example, as illustrated in FIG. 3, if the cursor displayed on the display 310 is located on news 2, a name, a broadcasting time 340, or the like of the news 2 may be displayed.

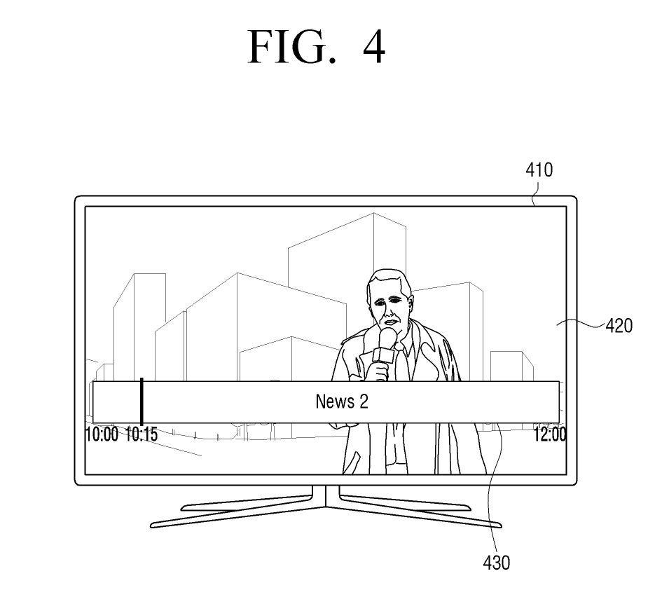

Meanwhile, if a user command for selecting a broadcasting program displayed on the user interface is received, the processor 220 may receive the selected broadcasting program from the server 100 and output the received broadcasting program. For example, if the news 2 is selected, as illustrated in FIG. 4, the processor 220 may receive video data and audio data for news 2 from the server 100 and output news 2 420.

In this way, the processor 220 may receive the broadcasting program through the broadcasting channel and output the received broadcasting program, and then may receive a broadcasting program broadcast before the corresponding broadcasting program through the VOD service and output the received broadcasting program.

Meanwhile, the processor 220 may output the progress bar indicating the playback point of the broadcasting program provided through the VOD service. For example, as illustrated in FIG. 4, the processor 220 may display a progress bar 430 indicating a playback point of news 2 on a display 410.

Accordingly, a user may receive a broadcasting program from his/her desired playback point using the progress bar. That is, if an object within the progress bar is moved, the processor 220 may output the broadcasting program from the playback point corresponding to the moved location.

Meanwhile, if a user command for searching for previous and subsequent broadcasting programs is input, the processor 220 may output a user interface indicating schedule information based on the information on the previous and subsequent broadcasting programs received from the server 100.

Here, the user command for searching for the previous and subsequent broadcasting programs may be a command for selecting a key provided for changing the playback point.

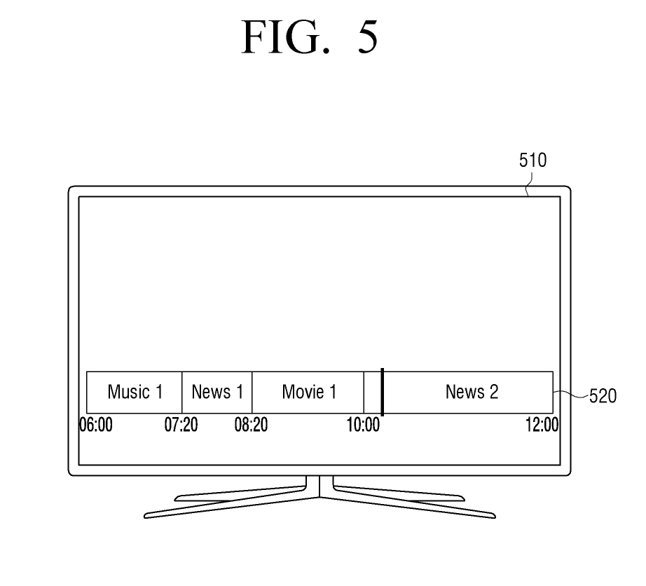

For example, if the REW key prepared for changing the playback point is selected to move an object (e.g., bar-shaped GUI) displayed within the progress bar to a left end, that is, if the object moves to a position corresponding to a start portion of the broadcasting program within the progress bar or if the FF key prepared for changing the playback point is selected to move an object displayed within the progress bar to a right end, that is, if the object moves to a position corresponding to an end portion of the broadcasting program within the progress bar, the processor 220 may output a user interface 520 indicating broadcasting schedule information for previous and subsequent broadcasting programs to a display 510, as illustrated in FIG. 5.

Meanwhile, the above example describes that the user interface is provided in a state in which a broadcasting program provided through a broadcasting channel is output, but the user interface may be provided in the same manner as the above-described method even in a state in which the broadcasting program provided through the VOD service or the PVR service is output.

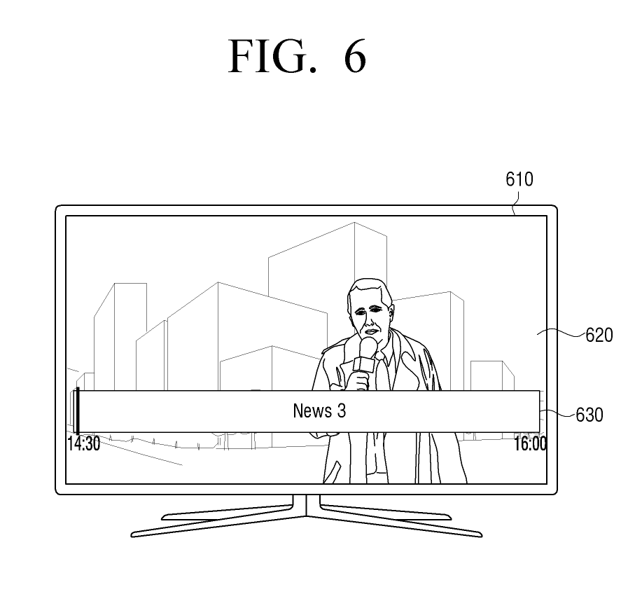

For example, as illustrated in FIG. 6, the processor 220 may output a broadcast program 620 provided through the VOD service to a display 610. At this time, the processor 220 may display a progress bar 630 indicating the playback point of the broadcast program.

At this point, if the user command for searching for the previous and subsequent broadcasting programs is input, the processor 220 may output the user interface indicating the schedule information to the display (not illustrated) based on the information on the previous and subsequent broadcasting programs received from the server 100.

Here, the user command for searching for the previous and subsequent broadcasting programs may be a command for selecting a key prepared for changing the playback point.

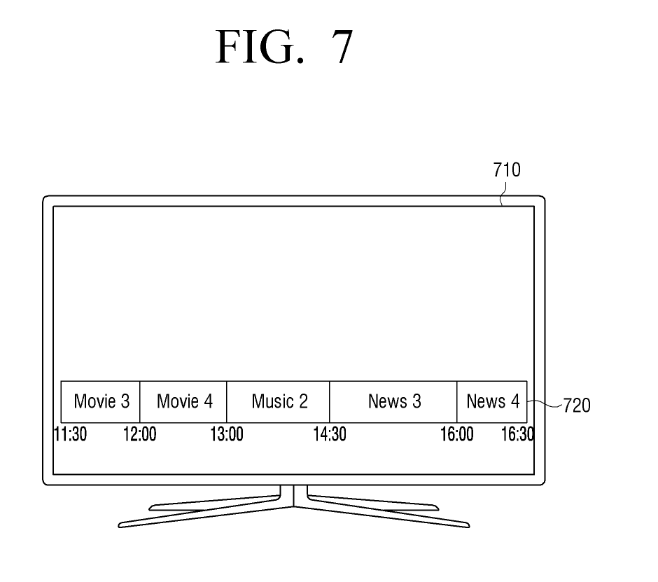

For example, if the REW key prepared for changing the playback point is selected to move an object displayed within the progress bar to a left end, that is, if the object moves to a position corresponding to a start portion of the broadcasting program within the progress bar or if the FF key prepared for changing the playback point is selected to move an object displayed within the progress bar to a right end, that is, if the object moves to a position corresponding to an end portion of the broadcasting program within the progress bar, the processor 220 may output a user interface 720 indicating broadcasting schedule information for previous and subsequent broadcasting programs to a display 710, as illustrated in FIG. 7.

In this case, the previous and subsequent broadcasting programs may be broadcasting programs broadcast before and after the corresponding broadcasting program on the channel on which the broadcasting program displayed on the electronic apparatus 200 through the VOD service is actually broadcast.

For example, as illustrated in FIG. 6, it is assumed that the electronic apparatus 200 receives and displays news 3 broadcast on CH 5 from 14:30 to 16:00 on Monday through the VOD service.

In this case, as illustrated in FIG. 7, the processor 220 may display the user interface 720 indicating a broadcasting schedule for movie 3, movie 4, and music 2 broadcast on CH5 before 14:30 to 16:00 on Monday and a broadcasting schedule for news 4 broadcast on CH5 after 14:30 to 16:00 on Monday.

Meanwhile, the above example describes that a user interface indicating a broadcasting schedule for a broadcasting program broadcast on the same channel as the broadcasting program displayed on the electronic apparatus 200 is displayed.

However, this is merely an example, and according to various exemplary embodiments of the present disclosure, broadcasting schedules for broadcasting programs broadcast on other channels as well as the same channel may be provided.

For this purpose, the server 100 may additionally store information on a name, a broadcasting time, or the like of a broadcasting program broadcast on another channel at time when the broadcasting program is broadcast, on each broadcasting program basis.

Here, other channels may include the previous channel and the subsequent channel of the channel on which the broadcasting program is broadcast.

For example, broadcasting program A was broadcast on CH 22 from 20:00 to 22:00 on Sunday, broadcasting program F was broadcast on CH 21 from 20:00 to 22:00 on Sunday, and broadcasting program G was broadcast on CH 23 from 20:00 to 21:00 on Sunday.

In this case, the storage 120 may store information on names, broadcasting time, or the like of the broadcasting programs F and G broadcast on other channels in the same time zone, in association with the broadcasting program A.

Accordingly, the electronic apparatus 200 may acquire information on broadcasting programs broadcast on other channels from the server 100 and display the user interface including the schedule information on the broadcasting programs broadcast on other channels.

For example, if the user command is input, the processor 220 may request the server 100 to transmit the information on the previous and subsequent broadcasting programs of the broadcasting program that is currently being output.

Specifically, if the user command is input, the processor 220 may transmit information on a broadcasting program that is currently being output to the server 100 through the communicator 210.

Here, the information on the broadcasting program may include the name, the broadcasting time, or the like of the broadcasting program.

In this case, if the information on the broadcasting program is received from the electronic apparatus 200, the server 100 may determine a broadcasting program matching the information on the corresponding broadcasting program and transmit information on a broadcasting program broadcast before and after the determined broadcasting program and information on broadcasting programs broadcast on other channels in the same time zone to the electronic apparatus 200.

Accordingly, the processor 220 may receive the information on the previous and subsequent broadcasting programs of the broadcasting program that is currently being output and the information on the broadcasting programs broadcast on other channels in the same time zone through the communicator 210.

Further, the processor 220 may display the user interface indicating the broadcasting schedule for the previous and subsequent broadcasting programs of the broadcasting program that is currently being output and the broadcasting programs broadcast on other channels in the same time zone as the corresponding broadcasting program.

For example, as illustrated in FIG. 6, it is assumed that the electronic apparatus 200 receives and displays news 3 broadcast on CH 5 from 14:30 to 16:00 on Monday through the VOD service. At this time, movie 3, movie 4, and music 2 were broadcast on CH 5 from 14:30 to 16:00 on Monday, news 4 was broadcast on CH 5 after 14:30 to 16:00 on Monday, news 5 was broadcast on CH 4 from 14:00 to 15:00 on Monday, and news 6 was broadcast on CH 6 from 14:00 to 16:00 on Monday.

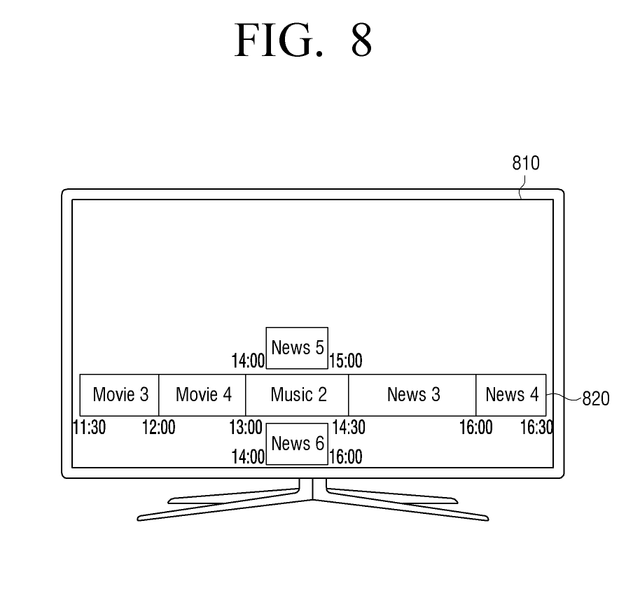

In this case, if user command is input, as illustrated in FIG. 8, the processor 220 may display a user interface 820 indicating broadcasting schedule information on movie 3, movie 4, and music 2 broadcast on CH 5 before 14:30 to 16:00 on Monday, news 4 broadcast on CH 5 after 14:30 to 16:00 on Monday, news 5 broadcast on CH 4 from 14:00 to 15:00 on Monday, and news 6 broadcast on CH 6 from 14:00 to 16:00 on Monday on a display 810.

Meanwhile, if a user command for selecting broadcasting programs broadcast on other channels among the broadcasting programs displayed on the user interface is received, the processor 220 may receive the information on the broadcasting programs broadcast before and after the broadcasting program selected on the corresponding channel from the server 100 and display the user interface indicating the broadcasting schedule information for the broadcasting programs broadcast before and after the broadcasting program based on the information on the received broadcasting program.

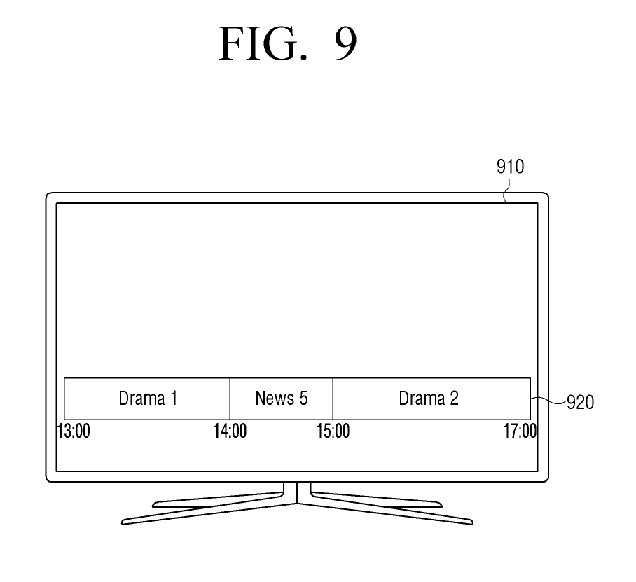

For example, it is assumed that drama 1 was broadcast on CH 4 from 13:00 to 14:00 and drama 2 was broadcast on CH 4 from 15:00 to 17:00. In this case, if or when news 5 broadcast on CH 4 from 14:00 to 15:00 on Monday is selected in the user interface, as illustrated in FIG. 9, the processor 220 may display a user interface 920 including a broadcasting schedule information for the drama 1, the news 5, and the drama 2 on a display 910.

Thereafter, if or when a broadcasting program is selected in the user interface, the processor 220 may receive the selected broadcasting program from the server 100 and output the selected broadcasting program.

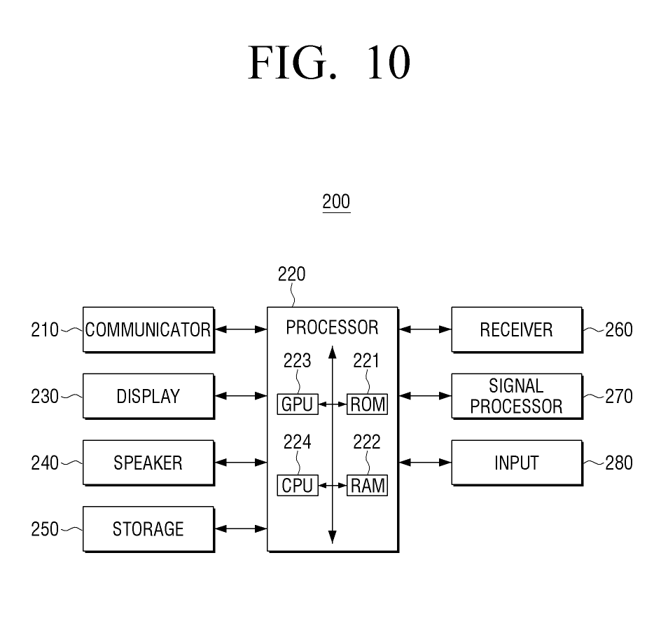

FIG. 10 is a block diagram illustrating a detailed configuration of an electronic apparatus according to an exemplary embodiment of the present disclosure.

Referring to FIG. 10, the electronic apparatus 200 includes the communicator 210, the processor 220, the display 230, a speaker 240, a storage 250, a receiver 260, a signal processor 270, and an input 280, which may be controlled by the processor 220.

Meanwhile, the communicator 210 and the processor 220 perform the same functions as those of the communicator 210 and the processor 220 illustrated in FIG. 2, and therefore redundant description of these components will be omitted.

The display 230 and the speaker 240 output a broadcasting program. Specifically, the display 230 may display video data for the broadcasting program, and the speaker 240 may output audio data for the broadcasting program.

The storage 250 may store commands or data that are received from the processor 220 or other components (e.g., communicator 210, display 230, speaker 240, storage 250, receiver 260, signal processor 270, input 280 or the like) or generated by the processor 220 or other components.

Further, the storage 250 may include programming modules such as a kernel, middleware, an application programming interface (API), and applications. Each of the above-described programming modules may be configured of software, firmware, hardware, or a combination of at least two of them.

Meanwhile, the storage 250 includes a storage (not illustrated) configured of an ROM (not illustrated), an RAM (not illustrated), and an SoC (not illustrated) of the processor 220, a memory card (e.g., micro SD card, USB memory, which are not illustrated) equipped in the electronic apparatus 200, and an external storage (for example, USB memory, or the like which is not illustrated) connectable to the electronic apparatus 200. In addition, the storage 250 may include a nonvolatile memory, a volatile memory, a hard disk drive (HDD), or a solid state drive (SSD).

The receiver 260 receives the broadcasting program. Specifically, the receiver 260 may receive broadcasting programs provided through a ground wave, a cable, IPTV, satellite broadcasting, or the like from the broadcasting stations or the broadcasters.

In the case of the example in which contents are received from the broadcasting stations or the broadcasters, the receiver 260 may be implemented to include components like a tuner (not illustrated), a demodulator (not illustrated), an equalizer (not illustrated), and the like. However, this is merely an example, and the receiver 260 may be implemented in various forms according to the implementation example.

The signal processor 270 performs signal processing on the broadcasting program so that the broadcasting program received through the communicator 210 and the receiver 260 may be output

Specifically, the signal processor 270 may perform various image processing such as decoding, scaling, noise filtering, frame rate conversion, and resolution conversion on a video signal included in the broadcasting contents and convert the video signal into a form which may be output from the display 230. Further, the signal processor 270 may perform various signal processings such as decoding, amplification, and noise filtering on an audio signal included in the broadcasting content to convert the audio signal into a form that may be output from the speaker 240.

In this case, the display 230 is a component that outputs various video signals processed by the signal processor 270. The display 230 may be implemented as a liquid crystal display (LCD), an organic light emitting diode (OLED) display, or the like to display an image or the like for a broadcasting program.

The speaker 240 is a component for outputting various kinds of notification sounds and voice messages as well as a component for outputting various audio signals processed by the signal processor 270. For example, the speaker 240 may output audio for the broadcasting program.

The input 280 receives various user commands for controlling the electronic apparatus 200 and transmits the user commands to the processor 220.

In this case, the input 280 may be implemented as an IR receiver (not illustrated) for receiving a remote control signal transmitted from a remote control for controlling the electronic apparatus 200. In some cases, the input 280 may be implemented as an input panel provided in the electronic apparatus 200. Here, the input panel may be implemented as a key pad or touch screen type including a touch pad or various function keys, a numeric key, a special key, a character key, or the like.

The input 280 may receive various user commands for controlling the functions of the electronic apparatus 200. For example, if the electronic apparatus 200 is implemented as a TV, the input may receive user operations for controlling a function of the TV, such as power on/off, channel switching, and volume change. In this case, the processor 220 may control other components to perform various functions corresponding to user operations input through the input 280.

Meanwhile, the processor 220 may include a ROM 221, a RAM 222, a graphic processor unit (GPU) 223, a CPU 224, and a bus. The ROM 221, the RAM 222, the GPU 223, the CPU 224, or the like may be connected to each other via the bus.

The CPU 224 accesses the storage 250 and performs booting using an operating system (O/S) stored in the storage 250. Further, the CPU 224 may perform various operations using various programs, contents, data, or the like that are stored in the storage 250.

The ROM 221 stores a command set for booting the system and the like. If a turn on command is input to supply power, the CPU 224 copies the O/S stored in the storage 250 to the RAM 222 according to the command stored in the ROM 221 and executes the O/S to boot the system. If the booting is completed, the CPU 224 copies various programs stored in the storage 250 to the RAM 222 and executes the program copied to the RAM 222 to perform various operations.

If the booting of the electronic apparatus 200 is completed, the GPU 223 can generate a screen including various objects such as an icon, an image, and a text. The GPU may be configured separately or may be configured like the SoC combined with a CPU in the processor 220.

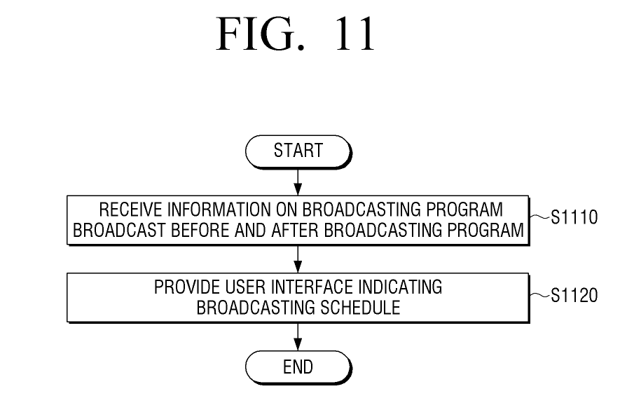

FIG. 11 is a flowchart illustrating a method of providing a broadcasting schedule of a electronic apparatus according to an exemplary embodiment of the present disclosure

First of all, the information on the previous broadcasting program broadcast before the broadcasting program and the subsequent broadcasting program broadcast after the broadcasting program on a channel on which the broadcasting program is broadcast is received from the server (S1110).

Further, the user interface indicating the broadcasting schedule for at least one of the previous broadcasting program, the broadcasting program, and the subsequent broadcasting program based on the received broadcasting program information is provided (S1120).

Meanwhile, the broadcasting program may be received from the server that stores a plurality of broadcasting programs.

In addition, in step S1130, the user interface in the progress bar type in which the previous broadcasting program, the broadcasting program, and the subsequent broadcasting program are divided into broadcasting program units and arranged in order of broadcasting time.

Meanwhile, the information on the broadcasting program may include the names and the broadcasting time of the previous broadcasting program, the broadcasting program, and the subsequent broadcasting program.

Meanwhile, the server may store the information on the broadcasting programs broadcast before and after the broadcasting program, on each broadcasting program basis.

Meanwhile, if or when the information on the first previous broadcasting program broadcast before the broadcasting program is received, the information on the broadcasting program broadcast before the first previous broadcasting program may be requested to the server based on the information on the first previous broadcasting program and the information on the second previous broadcasting program broadcast before the first previous broadcasting program may be received from the server.

In addition, if or when the information on the first subsequent broadcasting program broadcast after the broadcasting program is received, the information on the broadcasting program broadcast after the first subsequent broadcasting program may be requested to the server based on the information on the first subsequent broadcasting program and the information on the second subsequent broadcasting program broadcast after the first subsequent broadcasting program may be received from the server.

Further, if or when the broadcasting program is selected on the user interface, the broadcasting program selected from the server may be received.

Meanwhile, a non-transitory computer readable medium storing a program for sequentially performing the broadcasting schedule providing method according to the present disclosure may be provided.

The non-transitory computer readable medium does not mean a medium that stores data for a short period of time, such as a register, a cache, and a memory, but a medium that semi-permanently stores data and may be read by the device. Specifically, various applications or programs described above may be provided while being stored in the non-transitory computer readable media such as CD, DVD, a hard disk, a Blu-ray disk, USB, a memory card, and ROM.

Also, although a bus is not illustrated in the above-described block diagram of the electronic apparatus, the communication between the respective components in the electronic apparatus may be made via the bus. In addition, the electronic apparatus may further include processors such as a CPU, a microprocessor, or the like that performs various steps described above

While the exemplary embodiments of the present disclosure are illustrated and described above, it is clearly understood that the present disclosure is not limited to the foregoing particular exemplary embodiments and a person having ordinary skill to which the present disclosure pertains may variously change the present disclosure without departing from the spirit and scope of the present disclosure and the changed embodiments are not understood separately from the technical spirit or prospect of the present disclosure.

1. An electronic apparatus, comprising:
a communicator performing communication with a server; and
a processor configured to:
control the communicator to receive, from the server, a program stored in the server,
reproduce the program,
control the communicator to receive, from the server, information on a previous program broadcast before the program on a channel on which the program is broadcast and a subsequent program broadcast after the program on the channel on which the program is broadcast, and
provide a user interface that indicates a broadcasting schedule for at least one of the previous program, the program, and the subsequent broadcasting program based on the received information.

2. The electronic apparatus of claim 1, wherein the processor receives the program from the server in which a plurality of broadcasting programs are stored.

3. The electronic apparatus of claim 1, wherein the processor provides the user interface as a progress bar type in which the previous program, the broadcasting program, and the subsequent program are divided in program units and arranged in order of broadcasting time.

4. The electronic apparatus of claim 3, wherein the received information program includes a name and broadcasting time of the previous program, the program, and the subsequent program.

5. The electronic apparatus of claim 1, wherein the server stores programs information on the programs broadcast before and after the program, on each program basis.

6. The electronic apparatus of claim 1, wherein when information on a first previous program broadcast before the program is received, the processor requests information on a program broadcast before the first previous program to the server based on the information on the first previous program and receives information on a second previous program broadcast before the first previous program from the server.

7. The electronic apparatus of claim 1, wherein when information on a first subsequent program broadcast after the program is received, the processor requests information on a program broadcast after the first subsequent program to the server based on the information on the first subsequent program and receives information on a second subsequent program broadcast after the first subsequent program from the server.

8. The electronic apparatus of claim 1, wherein when the program is selected on the user interface, the processor receives the selected program from the server.

9. A method for providing a broadcasting schedule of an electronic apparatus, comprising:
receiving, from a server, a program stored in the server;
reproducing the program;
receiving, from the server, information on a previous program broadcast before the program on a channel on which the program is broadcast and a subsequent program broadcast after the program on the channel on which the program is broadcast; and
providing a user interface indicating the broadcasting schedule for at least one of the previous program, the program, and the subsequent program based on the received information.

10. The method of claim 9, further comprising:
receiving the program from the server storing a plurality of programs.

11. The method of claim 9, wherein a user interface in a progress bar type in which the previous program, the program, and the subsequent program are divided in program units and arranged in order of broadcasting time is provided.

12. The method of claim 11, wherein the received information on the program includes name and broadcasting time of the previous program, the program, and the subsequent program.

13. The method of claim 9, wherein the server stores information on programs broadcast before and after the program, on each program basis.

14. The method of claim 9, further comprising:
requesting information on a program broadcast before a first previous program to the server based on the first previous program and receiving information on a second previous program broadcast before the first previous program from the server, when the information on the first previous program broadcast before the program is received.

15. The method of claim 9, further comprising:
requesting information on a program broadcast after a first subsequent program from the server based on the information on the first subsequent program, and
receiving information on a second subsequent program broadcast after the first broadcasting program from the server, when the information on the first subsequent program broadcast after the program is received.

16. The method of claim 9, further comprising:
receiving a selected program from the server when the program is selected on the user interface.

17. A non-transitory computer-readable medium storing computer instructions, which when executed by a processor of an apparatus, causes the apparatus to perform operations comprising:
receiving a program stored in a server;
receiving information on a received program including a previous program broadcast before the program and information on a subsequent program broadcast after the program on a channel on which the program is broadcast from the server; and
providing a user interface indicating a broadcasting schedule for at least one of the previous program, the program, and the subsequent program based on the received information.
